(19) United States
(12) Patent Application Publication
(10) Pub. No.: US 2008/0154986 A1
(43) Pub. Date: Jun. 26, 2008

(54) System and Method for Compression of Data Objects in a Data Storage System

(75) Inventors: Ravi K. Kavuri, Inver Grove Heights, MN (US); James P. Hughes, Palo Alto, CA (US)

Correspondence Address: BROOKS KUSHMAN P.C. / SUN / STK, 1000 TOWN CENTER, TWENTY-SECOND FLOOR, SOUTHFIELD, MI, 48075-1238, US

(73) Assignee: STORAGE TECHNOLOGY CORPORATION, Louisville, CO (US)

(21) Appl. No.: 11/615,389

(22) Filed: Dec. 22, 2006

(51) Int. Cl. G06F 17/30

(52) U.S. Cl. 707/204; 707/E17.005

(57) ABSTRACT

A system for object-based archival data storage includes an object-based storage subsystem having respective data storage devices, an administration interface and a meta data subsystem for storing meta data about files. The system includes an algorithm for analyzing and conducting a reverse differential analysis and compression of data objects for storage and retrieval from the object storage subsystem.

### BACKGROUND OF THE INVENTION

1. Field of the Invention

The present invention relates to a system and a method for compression of data objects in a data storage system.

2. Background Art

Data storage systems typically have four main focus areas: free space management, access control, name and directories or name space management and local access to files. As data grows exponentially over time, storage management becomes an issue for all Information Technology (IT) managers. When a storage area network (SAN) is deployed, managing storage resources efficiently becomes even more complicated.

Conventional data storage systems are typically implemented to provide network-oriented environments as scalable and network-aware file systems that can satisfy both data storage requirements of individual systems and the data sharing requirements of workgroups and clusters of cooperative systems. Data objects in a conventional object-based storage system are mirrored across multiple storage devices and should be backed up for reliability and availability improvement. However, the object identifier for the mirrored object can be difficult to determine and to back up using conventional approaches.

Conventional approaches can fail to provide consistent and cost effective approaches to data back up, meta data management, data compression and the like. There may also be complications associated with the size and control over data object file versioning. The archive process may end up producing many versions of the same file. Storing every version of the file, in either full or compressed form, will waste storage space that may be more effectively used on the network.

Not only are these requirements driven by increases in the volume of data stored, but also by new information life cycle management (ILM) initiatives and compliance regulations that specify what must be stored, for how long must it be stored and accessible, as well as auditability requirements. Although ILM and compliance are not markets in and of themselves, the requirements drive the need for ILM and compliance related products.

### SUMMARY OF THE INVENTION

A system and a method for a data storage system that addresses deficiencies in conventional approaches. The improved system and method generally provides a data storage system including an object-based storage subsystem having respective data storage devices and a meta data subsystem for storing meta data about files, and includes a virtual file subsystem having a virtual file server (VFS). A data compression subsystem includes an algorithm for analyzing and compressing data objects, wherein the algorithm conducts a reverse differential compression on the data objects for storage and retrieval on the object-based storage subsystem.

The above features, and other features and advantages are readily apparent from the following detailed descriptions thereof when taken in connection with the accompanying drawings.

### BRIEF DESCRIPTION OF THE DRAWINGS

FIG. 1 is a diagram of a data storage system;

FIG. 2 is a diagram of a high level system architecture of the system;

FIG. 3 is another diagram of the data storage;

FIG. 4 is a diagram of logical flow of the data storage system;

FIG. 5 is a diagram of an exemplary data object archiving arrangement;

FIG. 6 is a diagram of a data object archiving and compression system and method; and

FIG. 7 is a block diagram of an algorithm for use with the system and method of performing reverse differential compression of data objects with the data storage system.

### DETAILED DESCRIPTION OF THE PREFERRED EMBODIMENT(S)

With reference to the Figures, the embodiments of the system and method will now be described in detail. An improved system and method for new and innovative techniques for the implementation of data storage systems.

The following abbreviations, acronyms and definitions are generally used in the Background and Summary above and in the Description below.

### CLI: Command Line Interface

Data object: A file that comprises data and procedures (i.e., routines, subroutines, ordered set of tasks for performing some action, etc.) to manipulate the data.

### FS: File server(s)

GUI: graphical user interface, a program interface that takes advantage of the computer's graphics capabilities to make the program easier to use. Well-designed graphical user interfaces can free the user from learning complex command languages. On the other hand, many users find that they work more effectively with a command-driven interface, especially if they already know the command language. The first graphical user interface was designed by Xerox Corporation's Palo Alto Research Center in the 1970s, but it was not until the 1980s and the emergence of the Apple Macintosh that graphical user interfaces became popular. One reason for their slow acceptance was the fact that they use considerable CPU power and a high-quality monitor, which until recently were prohibitively expensive. In addition to their visual components, graphical user interfaces also make it easier to move data from one application to another. A true GUI includes standard formats for representing text and graphics. Because the formats are well-defined, different programs that run under a common GUI can share data. This makes it possible, for example, to copy a graph created by a spreadsheet program into a document created by a word processor. Many DOS programs include some features of GUIs, such as menus, but are not graphics based. Such interfaces are sometimes called graphical character-based user interfaces to distinguish them from true GUIs. Graphical user interfaces, such as Microsoft Windows and the one used by the Apple Macintosh, feature the following basic components:

pointer: A symbol that appears on the display screen and that you move to select objects and commands. Usually, the pointer appears as a small angled arrow. Text-processing applications, however, use an I-beam pointer that is shaped like a capital I.

pointing device: A device, such as a mouse or trackball, that enables you to select objects on the display screen.

icons: Small pictures that represent commands, files, or windows. By moving the pointer to the icon and pressing a mouse button, you can execute a command or convert the icon into a window. You can also move the icons around the display screen as if they were real objects on your desk.

desktop: The area on the display screen where icons are grouped is often referred to as the desktop because the icons are intended to represent real objects on a real desktop.

windows: You can divide the screen into different areas. In each window, you can run a different program or display a different file. You can move windows around the display screen, and change their shape and size at will.

menus: Most graphical user interfaces let you execute commands by selecting a choice from a menu.

Hash: A function (or process) that converts an input (e.g., a input stream of data) from a large domain into an output in a smaller set (i.e., a hash value, e.g., an output stream). Various hash processes differ in the domain of the respective input streams and the set of the respective output streams and in how patterns and similarities of input streams generate the respective output streams. One example of a hash generation algorithm is Secure Hashing Algorithm-1 (SHA-1). Another example of a hash generation algorithm is Message Digest 5 (MD5). The hash may be generated using any appropriate algorithm to meet the design criteria of a particular application.
HTTP: Hyper Text Transfer Protocol. HTTP is the underlying protocol used by the World Wide Web. HTTP defines how messages are formatted and transmitted, and what actions Web servers and browsers should take in response to various commands. For example, when you enter a URL in your browser, this actually sends an HTTP command to the Web server directing it to fetch and transmit the requested Web page.

### HTTPS: Hyper Text Transfer Protocol Secure sockets (see SSL)

IP: Internet Protocol. IP specifies the format of packets, also called datagrams, and the addressing scheme. Most networks combine IP with a higher-level protocol called Transmission Control Protocol (TCP), collectively, TCP/IP, which establishes a virtual connection between a destination and a source.

### MDS: Meta-data (or meta data or metadata) server

Meta data (or metadata or meta-data): Data about data. Meta data is definitional data that provides information about or documentation of other data managed within an application or environment. For example, meta data would document data about data elements or attributes, (name, size, data type, etc) and data about records or data structures (length, fields, columns, etc) and data about data (where it is located, how it is associated, ownership, etc.). Meta data may include descriptive information about the context, quality and condition, or characteristics of the data.
Mirroring: Writing duplicate data to more than one device (usually two hard disks), in order to protect against loss of data in the event of device failure. This technique may be implemented in either hardware (sharing a disk controller and cables) or in software. When this technique is used with magnetic tape storage systems, it is usually called “twinning”.

### NAS: Network Attached Storage

Network: A group of two or more computer systems linked together. Computers on a network are sometimes called nodes. Computers and devices that allocate resources for a network are called servers. There are many types of computer networks, including:

a) local-area networks (LANs): The computers are geographically close together (that is, in the same building).

b) wide-area networks (WANs): The computers are farther apart and are connected by telephone lines or radio waves.

c) campus-area networks (CANs): The computers are within a limited geographic area, such as a campus or military base.

d) metropolitan-area networks MANs): A data network designed for a town or city.

e) home-area networks (HANs): A network contained within a user's home that connects a person's digital devices.

In addition to these types of computer networks, the following characteristics are also used to categorize different types of networks:

i) topology: The geometric arrangement of a computer system. Common topologies include a bus, star, and ring.

ii) protocol: The protocol defines a common set of rules and signals that computers on the network use to communicate. One of the most popular protocols for LANs is called Ethernet. Another popular LAN protocol for PCs is the IBM token-ring network.

iii) architecture: Networks can be broadly classified as using either a peer-to-peer or client/server architecture.

### NFS: Network File Server (or System)

### SAN: Storage Area Network

SSL: Secure Sockets Layer, a protocol developed by Netscape for transmitting private documents via the Internet. SSL works by using a private key to encrypt data that's transferred over the SSL connection. Both Netscape Navigator and Internet Explorer support SSL, and many Web sites use the protocol to obtain confidential user information, such as credit card numbers. By convention, URLs that use an SSL connection start with HTTPS: instead of HTTP:. Another protocol for transmitting data securely over the World Wide Web is Secure HTTP (S-HTTP). Whereas SSL creates a secure connection between a client and a server, over which any amount of data can be sent securely, S-HTTP is designed to transmit individual messages securely. SSL and S-HTTP, therefore, can be seen as complementary rather than competing technologies. Both protocols have been approved by the Internet Engineering Task Force (IETF) as a standard.
VFS: Virtual File Server or Virtual File System. The context of the particular use indicates whether the apparatus is a server or a system.

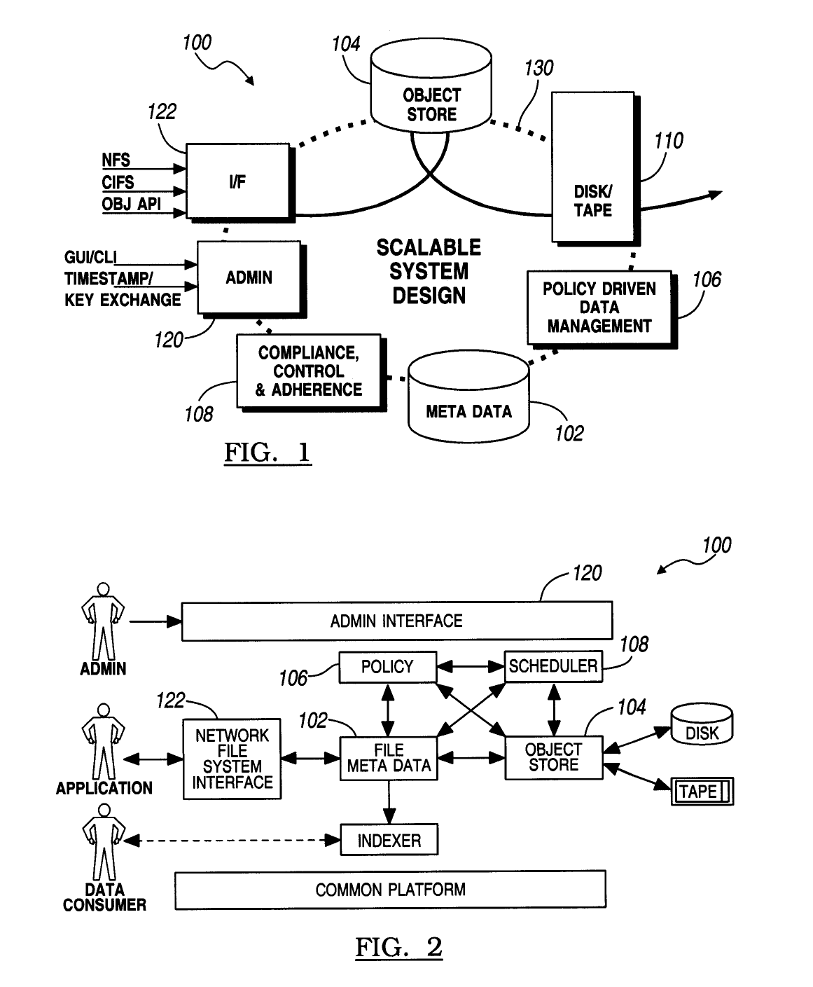

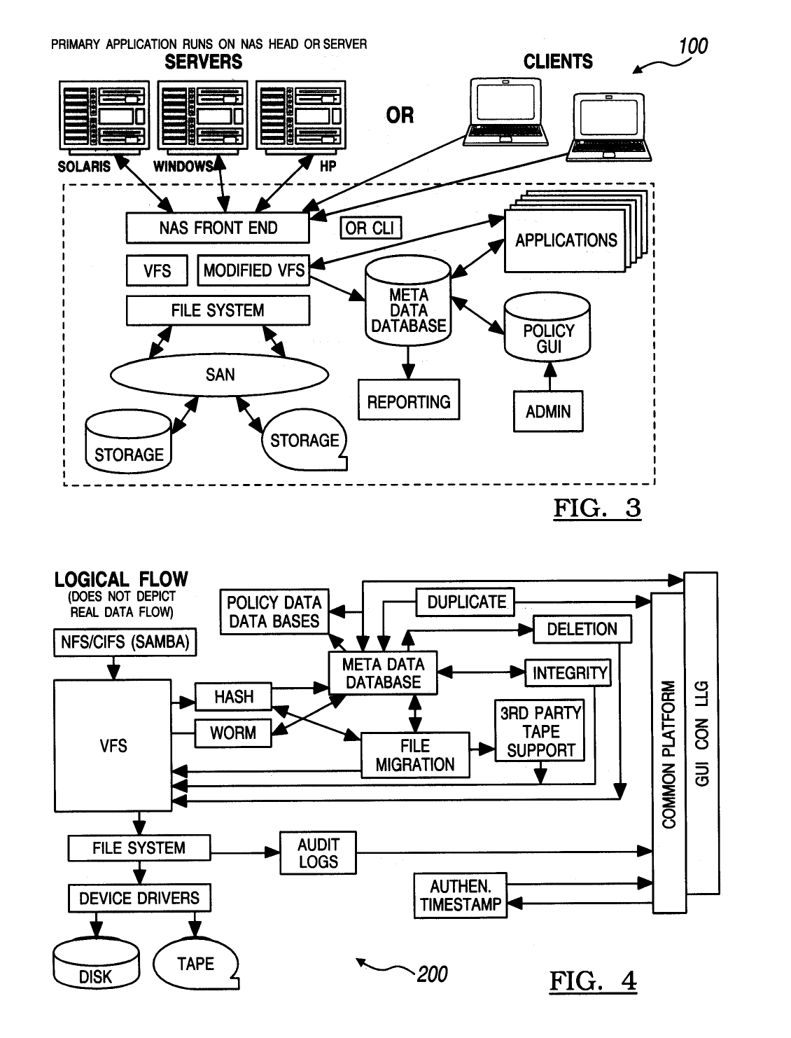

Referring to FIGS. 1-4, diagrams of a high level system architecture of a scalable data storage system 100 in accordance with the embodiments is shown. It is understood that the embodiments may be used with any type of storage solution configuration. The system described below is discussed for exemplary purposes.

The system 100 is generally implemented as a virtual library system or virtual file system (VFS). The virtual file system 100 generally comprises a meta data subsystem 102, an object subsystem 104, a policy driven data management subsystem 106, a compliance, control and adherence subsystem (e.g., scheduler subsystem) 108, a data storage (e.g., tape/disk) subsystem 110, an administration subsystem 120, and a file presentation interface structure 122 that are coupled to provide intercommunication via a scalable mesh/network 130.

The file system and meta data file system 102 generally stores and provides for the file system virtual file server (VFS) data about files, including local file system location (for meta data), object id (for data), hash, and presented file system information. The subsystem 102 further categorizes data into classes and maps classes to policies. The file meta data subsystem 102 may create from scratch: file meta data, hashing, classes, duplicate detection and handling, external time source, and serialization. Meta data subsystem 102 communicates with administration interface 120 and object store 104 to control and set the policies.

The object store 104 generally places data onto physical storage, manages free space, and uses the policy subsystem 106 to guide its respective actions. The object store 104 may provide mirrored writes to disk, optimization for billions of small objects, data security erase, i.e., expungement for obsolete data, and direct support for SCSI media change libraries. The object store 104 generally includes a control interface that works with object ids, may be agnostic to type of data, manages location of data, provides space management of disk and tape, includes a replica I/O that works as a syscall I/O interface, creates and replicates objects from FS, directs and determines based on policy for compression and encryption, links to other object store through message passing, and provides efficient placement of data on tape and tape space management, and policy engines that may be directed by the policy subsystem 106 for synchronous replication and .n demand creation of copies.

The policy subsystem 106 retains rules governing storage management that may include rules for duplicate detection and handling, integrity checking, and read-only status. The policy subsystem 106 generally comprises a policy control interface that generally interfaces with the administration I/F subsystem 120 to collect class and policy definitions, maintains and processes class and policy definitions, extracts data management rules, and maintains the hierarchy of functions to be performed, and rules engines that interface with the scheduler 108 to perform on demand and lazy scheduled activities of replica creation and migration, and receive system enforced policies based on maintained F/S meta data.

The scheduler subsystem 108 generally manages background activities, and may operate using absolute time based scheduling, and an external time source. The scheduler subsystem 108 generally comprises a job scheduler control interface that may be directed based on rules extracted from policy enforcement and the maintains the status of current and planned activity, and maintains priority of jobs to be performed, and a scheduler thread where system wide schedules are maintained. The scheduler thread can communicate and direct the object store 104 to duplicate, delete and migrate existing data, perform default system schedules and periodic audit, and may be directed by the FS subsystem 102 for deletion and expungement of data.

The administration interface subsystem 120 generally includes a GUI/CLI interface that supports HTTP and HTTPS with SSL support, supports remote CLI execution, provides and supports the functions of user authentication, administration of physical and logical resources, monitoring and extracting system activity and logs, and support of software and diagnostics maintenance functions, and an administration I/F that may communicate with all other major sub systems, maintain unique sessions with user personas of the system, and perform command and semantic validation of actions being performed. The subsystem 120 generally provides command level security, enforces command level security roles, and archive specific commands.

Security and audit and logging subsystems may be coupled to the administration interface subsystem 120. The security subsystem generally provides for the creation of users and roles for each user and assigns credentials, provides the ability to create resources and resource groups and assigns role based enforcement criterion, maintains pluggable security modules for validation, interfaces with key management system for symmetric key management, and provides rules for client authentication for physical resources such as disks and tapes.

The audit and logging sub system generally provides system wide logging capability, threshold management of audits and logs at local processing environments, ability to provide different notification mechanisms (e.g. e-mail, SNMP traps, etc.), ability to filter and extract desired information, and configurable parameters for the type and length of audit information to be kept by the system.

The object store services may include an administration interface which may provide mechanisms for GUI and CLI interfaces, create a common framework for a virtual library system and other applications, interface with other subsystems for configuration and information display, and enforce command level security. The object store services may further comprise an object store that generally manages disk and tape storage, provides managed multiple media types, creates multiple copies, deletes copies per policy, moves data between nodes, controls tape libraries, manages disk and tape media, and performs media reclamation (“garbage collection”).

The object store services further include a policy engine that is generally separated from the virtual library system object store and that provides rules repository for data management, is consulted by object store, may file meta data to enforce rules, and provides relative time based controls. The object store services may further comprise a scheduler that performs scheduled functions, is a generic mechanism that is independent of specific tasks that are provided by other subsystems. The meta data database may, in one example, be tested to 10,000,000 rows, provide mirrored storage, automatic backup processes, manual backup and restore processes.

The administration interface 120 may include archive specific commands, extended policy commands, and command level security checks. The object store subsystem 104 generally includes optimizations for small objects and grouping, mirrored write, remote storage, automatic movement to new media, policy based control on write-ability, encryption and compression, non-ACSLS based library control, and data security erase (expungement) for use with a storage area network 130.

The policy engine subsystem 106 may be implemented separately from the object store subsystem 104 and may add additional rules such as integrity checking (hash based), read-only/write-ability/erase-ability control, and duplicate data treatment (leave duplicates, collapse duplicates), controls for policy modifications, absolute time based controls. The scheduler subsystem 108 may include “fuzzy” timing. The network file system interface 122 generally presents file system from the file meta data subsystem 102 via the network to external servers.

The system 100 generally provides storage solutions that vary depending on business desires and regulatory risk, access desires, and customer compliance solution sophistication. The embodiments may fulfill desires that are not being addressed currently. The embodiment generally provides data storage to store-copy and catalog, data integrity to verify on create, copy and rebuild, verify on demand, and verify on schedule, data retention control to set expiration policies, expire data, expunge data, and authoritative time source.

The data base module may be a relational database that will contain meta data and information about configurations, retention, migration, number of copies, and will eventually be a searchable source for the user. Additional fields for customer use may be defined and accessed via the GUI. All policies and actions may be stored in the data base module for interaction with other modules.

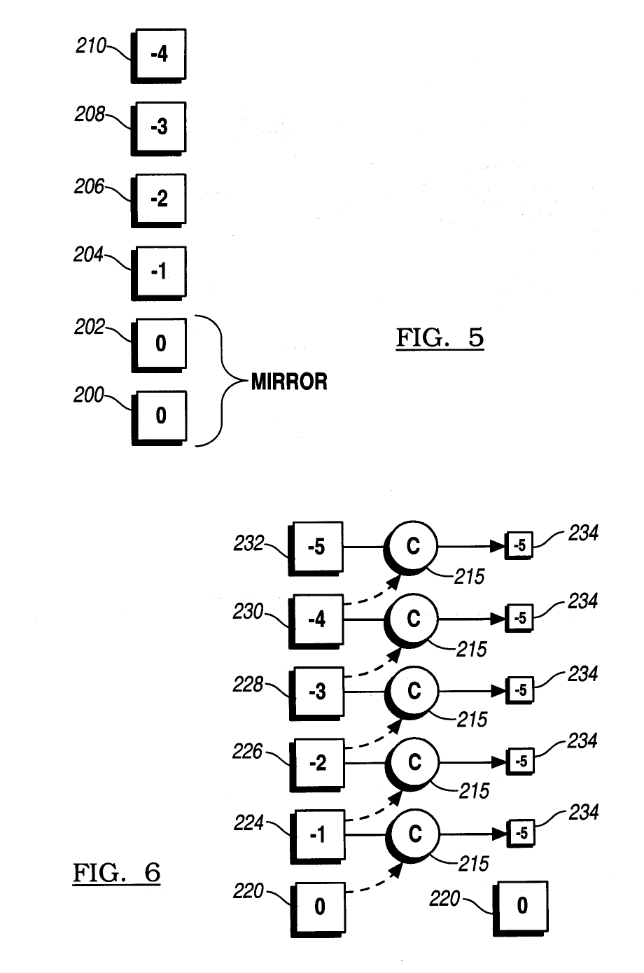

Referring now to FIGS. 5-7, a description of the system and method of data compression is described in greater detail. Data storage system utilizes a reverse differential compression method to compress data objects stored thereon, thereby reducing the overall size of the data to be stored and accessed on the system and the reducing the time associated with accessing and storing this data on the system.

As illustrated in FIG. 5, data storage system may store a variety of related and non-related files. Standard compression methods may create a number of files. For exemplary purposes, data storage system stores a data object 200, a mirrored copy of the data object 202, as well as data objects 204, 206, 208, 210. Data objects 204, 206, 208, 210 are prior versions of data object 200 that are stored for archive and retrieval purposes once data object 200 is updated. Data objects 204, 206, 208, 210 are stored to maintain version control of a document for storage purposes to track changes to the data object.

For exemplary purposes, data object 204 is one version older than the reference data object 200. Data object 206 is one version older than data object 204 and two versions older than current data object 200. It is understood that system may store an unlimited number of prior versions of the data object depending on design choices and storage abilities. System creates a duplicate copy of data object 200 in mirrored data object 202.

For archiving purposes, system maximizes the benefits of storing and maintaining prior versions of files by comparing each data object against the current data object 200 to determine the differences between the data objects. The file compression and archiving process is shown in FIG. 6.

Referring now to FIG. 6, data storage system may be configured to receive and store a reference data object 220. System includes a component or subsystem applying an algorithm that cooperates with one or more subsystems to analyze data object 220. System applies an algorithm to data object 220 at file comparison check, as shown by reference numeral 215, to determine various information about the objects, including meta data, object content and whether any updates were made in comparison to the prior version of the data object.

For example, component may apply algorithm may scan the meta data of the data object to determine whether any prior versions are stored on the system. Algorithm makes data object 220 the reference data object for purposes of further compression and archive. If the algorithm detects that data object 220 is modified or updated, the algorithm may separate mirrored copy of data object 222 from data object 220, creates archived data objects 224 and updates data objects 226, 228, 230 and 232 to indicate that a modification has been made to data object 220.

Unlike standard differential compression methods utilized in the industry, data storage system uses the entire content of data object 220 as the comparison file in a reverse differential compression process to determine changes between the data object 220 and the archived data objects. System then uses data object 220 to compress the older versions of the data objects as will be described in greater detail below. Archived data objects 224, 226, 228, 230 and 232 are compressed by comparing data in the objects against the data object 220 to determine the changes between the files.

In one example, data storage system analyzes the meta data and content of reference data object 220 against archived data objects 224, 226, 228, 230 and 232. Compression of an older version of the data object may simply be the removal of the common information to create a compressed data object, generally represented by reference numeral 234. The compressed data objects 234 will provide a significant reduction in storage space required on the data storage system.

A description of the compression algorithm used by a component of the data storage system is described in greater detail. Algorithm, as described above, uses of a reverse differential compression algorithm to compare a prior data object against a reference data object. The reference data object is used as a template and encodes a compressed or archived data object with only information that has changed since the last version update to reduce the overall size of the files stored on the system. It is contemplated that the algorithm may modify the meta data associated with both the reference data object and archived data object to determine dependencies between the objects.

Reverse differential data object compression methods reduce the amount of data transferred between the data storage system and a user. Reverse differential file compression also reduces the size of archive files by encoding only the version changes between the reference object and the archive object to reduce the size of data objects to be stored on the system. Reverse differential file compression also reduces the overall time required to back up files as compared with standard incremental backup processes.

Algorithm detects changes made between the reference data object 220 and a previous version of the data object 226. Based on the changes detected between the two files, algorithm creates compression data object 234 that may contain the differences between two versions of the data object. Algorithm continues this process through comparison of the remaining prior versions of the data object 228, 230, 232, thereby creating additional compression data objects 234 containing information about the differences in the prior version data object and the current version of the reference data object 220.

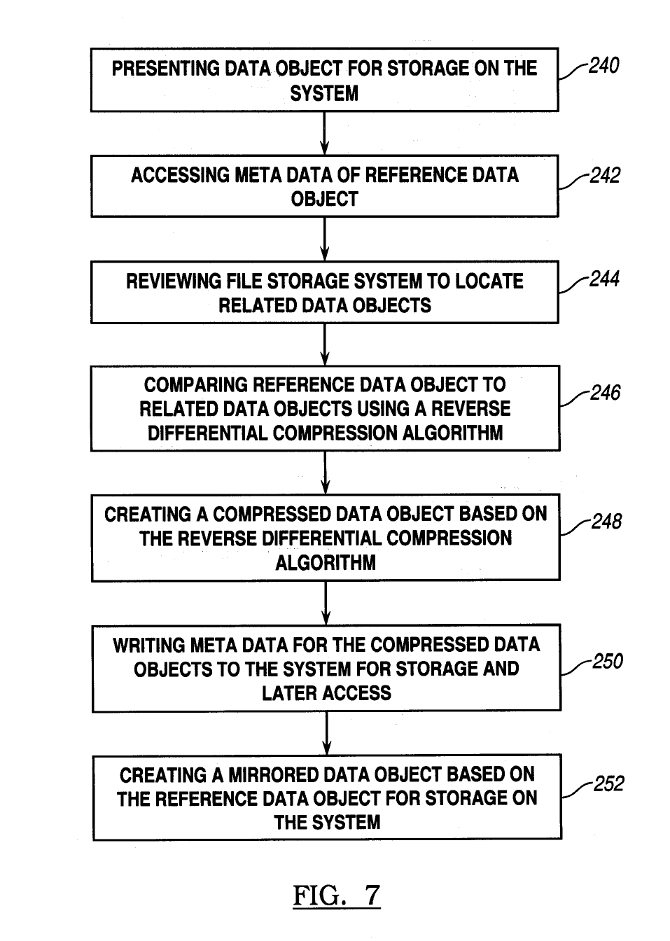

Referring additionally now to FIG. 7, the method of compressing data objects in a data storage system utilizing a reverse differential compression algorithm is described in greater detail. As represented by box 240 in the chart in FIG. 7, a data object is presented for storage onto the system in an uncompressed condition. The system accesses the data object at step 242 to review the meta data, file information and content associated with the object to prepare the object for use as the reference data object. At step 244, the system reviews the data storage system to locate any archive data objects that are related to the reference data object.

At step 246, the algorithm may sever the relationship between the mirrored data object and the reference data object if the reference data object has been modified from a previous version. The mirrored data object may be converted to an archived data object for review by the algorithm. It is understood that the algorithm may also create a distinct archive data object for the set. The system applies the reverse differential compression algorithm at step 248 to review the updated portions of the reference data object against each of the existing archive data objects to detect differences between the reference data object and each version data object.

At step 250, algorithm creates a compressed data object for each archive data object that represents and contains only data that differs from the reference data object 220. At step 252, the algorithm writes the meta data for each of the compressed data objects to the system for storage purposes. At step 254, the algorithm creates a mirrored data object for the reference data object. It is understood that one or more of the steps described above may be accomplished in a single step or may be broken out into additional steps based on design preferences.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for object-based archival data storage, the system comprising:
an object-based storage subsystem having respective data storage devices;
a meta data subsystem for storing meta data about files, and includes a virtual file subsystem having a virtual file server (VFS); and
a data compression subsystem for analyzing and compressing one or more data objects, the data compression subsystem having an algorithm conducting a reverse differential compression on the data objects for storage and retrieval on the object-based storage subsystem.

2. The system of claim 1 further comprising:
at least one file presentation interface that interfaces to client platforms;
an administration interface having graphical user interface (GUI) and a command line interface (CLI); and
a policy subsystem cooperating with the algorithm to analyze, compress, store and retrieve object data on the object-based storage system.

3. The system of claim 2 further comprising a scalable interconnect to couple the object-based storage subsystem, the at least one file presentation interface, the administration interface, the meta data subsystem, and the policy subsystem.

4. The system according to claim 1 wherein the algorithm reviews the meta data of the reference data object to locate related data objects on the data storage system.

5. The system according to claim 1 wherein the algorithm creates a compressed data object containing data based on a determination of the differences between the reference data object and the stored data object.

6. The system according to claim 1 wherein the algorithm creates a mirror image file of the reference data object for storage.

7. A method of object-based archival data storage, the method comprising:
interconnecting:
an object-based storage subsystem having respective data storage devices;
a meta data subsystem for storing meta data about files, and includes a virtual file subsystem having a virtual file server (VFS);
providing an algorithm for analyzing data objects for storage and retrieval from the object-based storage system;
presenting a data object for storage on the object-based storage system;
implementing the algorithm to conduct a reverse differential compression of the data object for storage and retrieval on the object-based storage subsystem; and
creating one or more compressed data objects on the system based on the reverse differential compression of the data object.

8. The method of claim 7 wherein the object-based storage subsystem stores data onto physical storage and manages free space in response to the policy subsystem rules, and provides at least one of mirrored writes to disk, optimization for small objects, data security erase via expungement of obsolete data, and direct support for media change libraries.

9. The method of claim 7 further comprising the step of accessing meta data of the data object for storage on the object-based storage system to locate related data objects on the system.

10. The method of claim 9 further comprising the step of comparing the reference data object against the related data objects to determine the differences between the objects.

11. The method of claim 7 further comprising the step of creating a mirrored data object for storage on the system based on the reference data object.

12. For use in an object-based archival data storage system, an algorithm for conducting a reverse differential compression of data objects, the algorithm comprising:
providing a reference data object for storage on the object-based storage system;
analyzing meta data associated with the reference data object to determine whether related data objects are stored on the system;
conducting a reverse differential compression of the reference data object and the related data objects;
comparing the reference data object against the related data objects to determine the differences between the objects; and
creating one or more compressed data objects that record the differences between the reference data object and the related data objects.

13. The method of claim 12 further comprising the step of creating a mirrored data object for storage on the system based on the reference data object.
